(19) United States
(12) Patent Application Publication
(10) Pub. No.: US 2020/0001552 A1
(43) Pub. Date: Jan. 2, 2020

(54) MOBILE PLATFORM FOR CABLE-DRIVEN PARALLEL ROBOT, CABLE-DRIVEN PARALLEL ROBOT, INSTALLATION AND METHOD FOR DRAPING USING SUCH A ROBOT

(71) Applicant: INSTITUT DE RECHERCHE TECHNOLOGIQUE JULES VERNE, Bouguenais (FR)

(72) Inventors: Matthieu KNEVELER, Les Sorinieres (FR); Alexis GIRIN, Treillieres (FR); Stephane CARO, Nantes (FR)

(73) Assignee: INSTITUT DE RECHERCHE TECHNOLOGIQUE JULES VERNE, Bouguenais (FR)

(21) Appl. No.: 16/493,536

(22) PCT Filed: Mar. 9, 2018
(86) PCT No.: PCT/EP2018/055969

§ 371 Date: Sep. 12, 2019

(30) Foreign Application Priority Data
Mar. 13, 2017 (FR) 1752008

(51) Int. Cl. B29C 70/38; B25J 9/00

(52) U.S. Cl. CPC B29C 70/388; B29K 2105/0845; B25J 9/0078

(57) ABSTRACT

A mobile platform which is designed to equip a cable-driven parallel robot, characterized in that the platform is configured to support at least one roll of a fabric made of composite material, and to permit the unwinding of said at least one roll, in order to carry out draping of a preform, in particular a dry preform, by controlled displacement of the platform above a draping line.

### FIELD OF THE INVENTION

The present invention relates to robotization of draping of preforms, in particular dry preforms made of composite material.

In particular, the invention relates to a mobile platform for a cable-driven parallel robot, a cable-driven parallel robot comprising a platform of this type, and a method for draping by means of a robot of this type.

### PRIOR ART

It is known to carry out draping of a preform using a robot.

Thus, a robot is known from DE 102006060361, which handles a drum, which, by means of aspiration openings, collects a strip of flexible material, in order then to drape a part.

An automated draping device is also known from FR 2 950 285, comprising a rigid gantry and a drum system which collects a cut-out strip before draping a form.

Finally, a rigid gantry is known from DE 102011050099, which supports grasping grippers which make it possible to drape a preform by putting into place a strip of pre-impregnated composite material which is collected and retained before being put into place by means of the grasping grippers.

These devices take up a significant amount of space, requiring a rigid heavy frame, which furthermore is for draping of large-sized preforms.

In addition, these devices may not be sufficiently accurate for depositing of the strips, in particular relative to one another.

Finally, the pace of draping by means of such devices may be insufficient.

There is therefore a need to produce large-sized preforms by means of automated draping.

There is also a need to benefit from an automated draping system which takes up relatively little space, and permits the intervention of other tools or robots in the same space.

There is also an advantage in having automated draping with satisfactory precision and a relatively fast pace.

Mobile Platform

According to one of its aspects, the subject of the present invention is thus a mobile platform which is designed to equip a cable-driven parallel robot, the platform being configured to support at least one roll of a fabric made of composite material, and to permit the unwinding of said at least one roll, in order to carry out draping of a preform, in particular a dry preform, by controlled displacement of the platform above a draping line.

Thanks to the invention, it is possible to produce preforms, in particular but not exclusively, large-sized preforms, in an automated manner, without requiring a cumbersome heavy frame. It is possible to dispense with a structure of a cumbersome rigid gantry type in order to produce preforms of this type. “Large-sized preforms” means preforms with a width and/or a length of more than 1 m, in particular between approximately 2 m and 100 m.

The platform can be configured to accommodate at least one roll of fabric.

The or each roll can have a width, measured along its axis, of more than 1 m, in particular more than 2 m, in particular equal to 3 m or more. The or each roll can have a fabric length of more than 2 m, in particular more than 4 m, in particular equal to 10 m or more, or 20 m or more, or 50 m or more, and can be equal to approximately 100 m. The or each roll can have an initial weight, including fabric, of more than 100 kg, in particular more than 500 kg, in particular between 200 kg and 2 t, for example between 500 kg and 1.2 t.

The platform can comprise a support for a roll/rolls. This support, which is designed to support the roll(s) is for example connected to the platform by a securing system. The latter is advantageously configured such as to permit controlled displacement in translation and/or in rotation of the support for the roll(s) relative to the remainder of the platform.

The securing system can comprise a mechanical system which permits guided displacement, selected from at least a slide, a rail, a roller, a sliding shaft, and any combination thereof. The support for the roll(s) can be fitted on a securing system of this type, for example a slide, such as to permit displacement in lateral translation of the support for the roll(s), parallel to the axis of the roll, relative to the remainder of the platform, and optionally slight displacement in rotation, in particular of between −5° and 5°, or between −3° and 3°, around a vertical axis Z. A rotation of this type can be fixed, or it can be carried out as the draping takes place, in the form of compensation, if necessary.

This controlled mobility of the support for the roll(s) relative to the platform can make it possible to adjust the position of the roll without needing to command the displacement of the platform assembly. The means for control of the displacement of the support for the roll(s) relative to the platform advantageously comprise a jack, a gear system, at least one belt and/or at least one roller. The displacement of the platform permits large displacements, or so-called “macroscopic” displacements, whereas the displacement of the support for the roll relative to the platform permits small displacements, or so-called precision “microscopic” displacements. The displacement of the support for the roll(s) relative to the platform makes it possible to correct the lack of precision of the robot.

According to a variant, the system for securing the support on the platform is configured to prevent any lateral mobility of the support relative to the platform.

The platform can comprise means for rotation of the roll in order to allow it to be unwound. These means for rotation can comprise at least one drive roller which is in contact with the shaft or a mandrel of the roll, and at least one motor which rotates the drive roller which, by friction, rotates the shaft or mandrel of the roll. As a variant, other drive means are used, such as, for example, a mandrel which is integrated in the mandrel of the roll, a drive pinion, a belt between the roll and the roller in contact with the fabric, or a roller which is free in rotation on the fabric, equipped with an encoder which records the displacement transmitted to a motor on the mandrel of the roll, or also external cameras which record the displacement of the platform, thus allowing the rotation of the roll to be controlled.

The platform can comprise a system for cutting the fabric. A cutting system of this type can be supported by the support for the roll(s), which is preferably on the path of the fabric when it is unwound. The cutting system advantageously comprises at least one blade, in order to be able to cut the strip of fabric unwound to the required length. The cutting system can comprise a disc with rotation guided in a groove, the fabric being between the disc and the groove. The cutting system can comprise means for retention of the fabric, for example by gripping, in order to permit the cutting.

The platform can comprise a system for guiding of the fabric. The system can comprise at least one guide plate and/or a roller, which is free in rotation in order to accompany the unwinding of the fabric, whilst guiding it on its path. The system for guiding of the fabric can comprise, in addition or alternatively, at least one, and in particular a plurality of bands, preferably made of elastomer, the displacement of which is controlled by the rotation of the roll. The mechanical guiding of the fabric, in particular at its lateral edges, can make it possible to determine its position precisely at all times.

The platform can comprise means for perception of the relief and/or of a contrast of appearance, such as at least one laser profile meter or at least one thermal camera. Such means for perception can be configured to detect a reference on the draping line, for example an edge of a band, or strip, of fabric already deposited, or an edge of a draping table, or a reference such as a thick self-adhesive tape, for example thanks to the relief generated thereby. The means for perception thus make it possible to detect a fixed point of the platform or of the roll support relative to these references, and thus the positioning of a band of fabric being deposited relative to these references. It should be noted that it is necessary to place side-by-side, i.e. to make contiguous, two adjacent strips or bands of fabric on a draping, in order to ensure the mechanical properties of the final part.

The means for perception can also make it possible to carry out measurements of the length of the fabric unwound during the draping, and/or measurements of the position of the fabric or the platform relative to the depositing line. The means for perception are advantageously integral in displacement with the support for the roll(s). Thus, displacement of the support relative to the platform gives rise to an associated displacement, which is identical or proportional for example, of the means for perception.

The means for perception can comprise a laser profile meter. As a variant, the means for perception can comprise at least two laser profile meters, in order to detect an angle and make it possible to carry out a correction dynamically.

The platform advantageously comprises a system for correction, in particular in real time, of the position of the fabric before draping, such as, for example, in order to obtain good precision of the positioning of two bands of fabric situated side-by-side. This correction system is preferably configured to take into consideration the data, in particular the geometric data, received by the means for perception. The correction system and the means for perception can be interdependent, and can be designed accordingly, at least in terms of geometric precision.

The correction system can be configured to command a displacement of the support for the roll(s) relative to the platform, according to the data received by the means for perception. As a variant, the correction system can be configured to command a displacement of the platform.

The correction system and the means for perception can be implemented before a strip is deposited, in order to position the support for the roll(s) correctly for the depositing of the strip, according to a predetermined placement, for example in a manner which is contiguous to a strip already deposited. As a variant, the means for perception and the correction system can be implemented dynamically, or in real time, i.e. as the strip is deposited, in order to adjust the position of the fabric as the platform advances.

The fabric of the or each roll can be of the Non-Crimp Fabric (NCF) type. In this case, the fabric comprises a plurality of layers of one-way fibers disposed on one another with a different angular orientation of the fibers. As a variant, the fabric is woven. The fabric can be deformable, i.e. composed of continuous fibers arranged in directions defined and assembled in a woven or non-woven form.

The fibers which constitute the fabric can be selected from the group constituted by carbon fibers, glass fibers, aramid fibers, ceramic fibers, polyester fibers, fibers of vegetable origin, in particular linen fibers, preferably carbon or glass fibers, and any mixture thereof. The fibers can be continuous or short.

In order to produce the fabric, it is possible to use non-woven NCF fibers, which form a raw material which has a lower cost than woven fibers. In addition, it is possible to select the orientation of the fibers for the draping, which makes it possible to control the mechanical properties of the part which will be produced from the preform, or to obtain improved performance.

The fabric wound on a roll can have a width of between approximately 1 m and 4 m.

The fabric can be selected such as to make it possible to provide a dry preform, by draping of the preform. “Dry preform” means a fibrous preform comprising less than approximately 20%, in particular less than approximately 5%, of a heat-setting or thermoplastic polymer, as a weight percent relative to the total weight of the preform. The preform can comprise a plurality of layers, which are or are not separated from one another by a plurality of inserts, for example made of foam, in particular PET (polyethylene terephthalate) foam, or of one-way carbon fabric, which layers are for example connected to one another by one or a plurality of seams. The depositing of inserts and/or the production of seams can be ensured by the platform of the cable-driven parallel robot, or by another robot, or also manually. In the case when the platform carries out the depositing of inserts and/or the seams, it will be appreciated that it is equipped with effectors which are designed for the depositing of inserts and/or the production of seams.

The dry preform can be used as a phase for reinforcement of a composite material. The preform can be draped flat or not flat. In this last case, it can be draped on a form which is not flat for example. The preform can then be displaced in order to be thermoformed and/or impregnated with at least one polymer, in a mold, in order to form a final part. The final part can be obtained by impregnation, in particular injection or infusion, of a polymer in the liquid or paste state into said dry preform.

It is possible to heat the preform during the draping. In this case, the fabric can be powdered, and the platform can comprise a system for heating, for example by blowing of hot air, just after depositing of the fabric, gradually, with a presser roller.

Cable-Driven Parallel Robot

According to another one of its aspects, in combination with the foregoing information, the present invention also relates to a cable-driven parallel robot, comprising:

a platform as defined above;

a plurality of cables extending between a point of anchorage on the platform and an anchorage connected to a structure which is fixed in space;

a motor assembly in order to carry out the winding or unwinding of the cables;

a control assembly in order to control the displacement of the platform and/or the displacement of the support for the roll(s) relative to the platform and/or the unwinding of the fabric from the roll.

The “cable-driven parallel robot” or “cable robot” is a robot with parallel kinematics, wherein the platform is positioned and displaced in space by means of cables acting on said platform. Each cable extends between a point of anchorage on this platform, and for example a winch which is secured on a fixed structure, the winch constituting an anchorage. The substantial capacity for variation of the cable length between the point of anchorage and the anchorage makes it possible to obtain a volume of work of the platform which is particularly large with a structure which is light and is easily put into place, by installing the anchorages for example on the ceiling of a workshop. The stability of the platform in a given position is ensured by its static equilibrium, which equilibrium is ensured by the tension of the cables which act such as to oppose the external forces to which the platform is subjected. Thus, in order to ensure the stability of any position and orientation of the platform in space, a minimum of seven cables is necessary. The cable-driven parallel robot operates with a plurality of kinematic chains or closed loops.

The positions of the anchorages need not be contained on the same plane.

The number of cables supporting the platform is advantageously equal to eight. This makes it possible to provide the robot with six degrees of freedom, and thus to obtain satisfactory precision in the control of the robot in its draping task. In fact, when the cable-driven parallel robot comprises eight cables, this makes it possible to control the three degrees of freedom in translation and the three degrees of freedom in rotation of the mobile platform in a large space.

As a variant, the number of cables can be less than eight, for example equal to seven. It should be noted that, for reasons of symmetry of the architecture of the robot, the presence of eight cables is preferred. In addition, this makes it possible to have a larger working space, although the risk of collisions between cables increases with the number of cables.

It should be noted that, also as a variant, the number of cables can be more than eight, for example more than or equal to nine, ten or also twelve cables, or fifteen or twenty cables. When the number of cables is more than eight, there may be redundancy of cables, which makes it possible to increase the possibility of rotation of the platform.

Each cable can make it possible to support up to 2 t for example. Each cable can measure approximately 150 m for example.

The control assembly can be configured to control the displacement of the platform and/or of the support for the roll(s) when the roll is unwound. The control assembly can receive data, as previously mentioned, obtained from the means for perception, such as to take the data into account in order to carry out its control tasks. The control assembly can comprise a control for position, speed or torque of the cable-driven parallel robot, in particular according to the information concerning the position of the platform relative to a strip previously deposited, obtained by means of the means for perception, such as the laser profile meter. The control assembly can comprise a control known as the sensor, consisting of taking into account the measurements made by the means for perception during taking of the measurements, dynamically, and of correcting in real time the position of the platform and/or the support for the roll(s) according to these measurements.

In nominal operating mode, the robot is for example designed to ensure linear displacement of the platform along a draping or depositing axis Y, at a constant altitude along the vertical axis Z, and at a speed which is advantageously correlated to the unwinding of the roll of fabric. The displacement of the platform along an axis X which is transverse to the draping axis Y can be designed to be as slight as possible. However, errors of position of the mobile platform of the robot along this axis X can be corrected by means of the means for perception, such as the laser profile meter, of the correction system, and by means of an actuator, which for example controls the displacement of the support for the roll(s) relative to the platform, which can be integrated in the platform, in particular at the support for the roll. It should be noted that the displacements of the platform associated with the depositing of the band of fabric for the draping need not be limited simply to the movements along the draping axis Y. In fact, all the movements on the plane (X, Y) can be carried out according to the preform to be produced.

In particular when it is supported by eight cables, the platform can carry out the following functions: ensure normal displacement during the depositing or draping, cut the band of fabric deposited to the required length, and perform rotation around a vertical axis Z.

The speed of displacement of the platform during the draping can be constant.

Installation for the Draping of Preforms

According to another one of its aspects, in combination with the foregoing, the present invention relates to an installation for draping of preforms, in particular large-sized preforms, comprising a robot as defined above and a fixed structure. The fixed structure is designed to receive the anchorages of the cables which retain the platform, and optionally all or part of the motor assembly of the robot. All or part of the anchorages of the cables can or need not be mobile within the fixed structure.

The installation can comprise a plurality of cameras secured on the fixed structure, making it possible to control the positioning of the platform and/or the roll relative to the draping line and/or relative to a mold or a strip previously deposited. The presence of cameras of this type can make it possible to replace the means for perception.

The fixed structure of the installation can be modular. This makes it possible to modify the installation relatively easily, for example according to the preform(s) to be produced, contrary to the known fixed structures of the gantry type.

The installation can have a draping line forming a production line of the preform, comprising a surface for receipt of the draping. In particular, on this line, the installation can comprise a system for grasping the fabric, which in particular is designed to retain an end of the fabric of the roll during the draping. The system for grasping the fabric can be designed to be able to be displaced on the production line, its positioning being controlled for example by the winding or unwinding of one or a plurality of cables with which it is integral. The system for grasping the fabric can comprise a gripper, an adhesion system, an aspiration system or a needle system, for example.

The installation can comprise a mold on which the draping is carried out.

An installation of this type can make it possible to carry out draping at a pace of 250 kg/h, or 500 kg/h, or better still 1000 kg/h.

The preform to be produced can comprise a plurality of layers, for example at least 10, in particular at least 20, with a number which can be between 30 and 50 layers.

Draping Method

According to another one of its aspects, in combination with the foregoing, the invention relates to a method for draping by means of an installation as defined above, comprising the step consisting of displacing the platform and unwinding the roll, in order to carry out the draping, the speed of unwinding of the roll being dependent on the speed of advance along the draping axis of the platform.

Thanks to this aspect of the invention, it is possible to obtain good monitoring of the depositing trajectory required, whilst having a control algorithm for the parallel robot with eight cables which can continue to be relatively simple.

The method can also comprise the step consisting of cutting the fabric whilst maintaining the fabric taut, to the required length of fabric unwound, this step optionally being preceded by the step consisting of displacing the platform vertically.

The method can comprise the step consisting of retaining an end of the fabric of the roll before unwinding the fabric, in particular by means of a system for grasping the fabric.

The method can comprise the step consisting of detecting, by means of the means for perception of the relief and/or a contrast of appearance, such as a laser profile meter or a thermal camera, a reference on the draping line, in particular an edge of a band or strip of fabric already deposited, an edge of a draping table, or a reference on the draping line, such as a thick self-adhesive tape. The relative measurement of the position of the existing band or of the first band is preferably carried out with a laser profile meter which can quantify the difference of level created by the bands deposited.

The method can also comprise the step consisting of displacing the support for the roll(s) relative to the platform, in order to correct a position of the platform, in particular by means of the system for correction in real time of the position of the fabric before draping.

### FIGURES

The invention will be able to be better understood by reading the following description of a non-limiting embodiment thereof, and by examining the appended drawing in which:

FIG. 1 represents schematically and in perspective an installation according to the invention comprising a cable-driven parallel robot according to the invention;

FIG. 2 is a schematic view in perspective of the platform according to the invention in FIG. 1;

FIG. 3 is an enlarged schematic view in perspective of a detail of FIG. 1;

FIG. 4 is a partial schematic view from the side of another example of an installation according to the invention; and

FIG. 5 represents the draping table in FIG. 4 seen from a perpendicular side.

### DETAILED DESCRIPTION OF AN EMBODIMENT

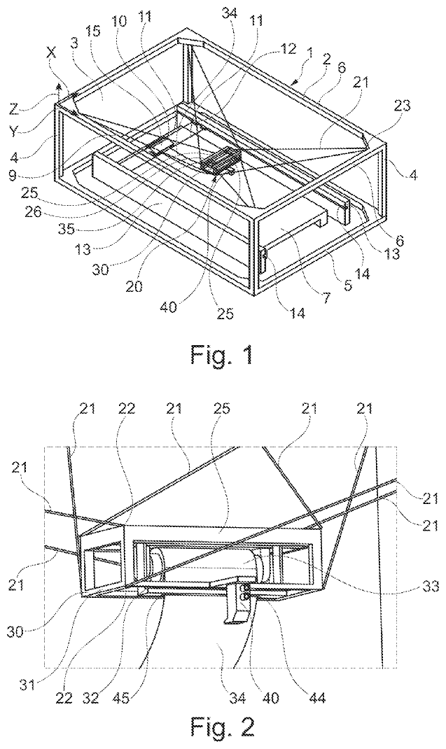

FIG. 1 represents an installation 1 according to an embodiment of the invention, comprising a fixed structure 2 which can or need not be partly formed by the structure of a building.

In this example, this fixed structure 2 forms an open rectangular parallelepiped defining an interior volume which is not closed. The rectangular parallelepiped comprises four lower beams 5 forming a rectangle on the ground, as well as four upper beams 6, parallel to the lower beams 5, forming a rectangle in height, the rectangles being connected to one another at the corners by vertical uprights 4.

The installation 1 also comprises a line 7 for draping or depositing of bands of fabric. In this example, the draping line 7 comprises a flat depositing space, such as to provide a flat preform.

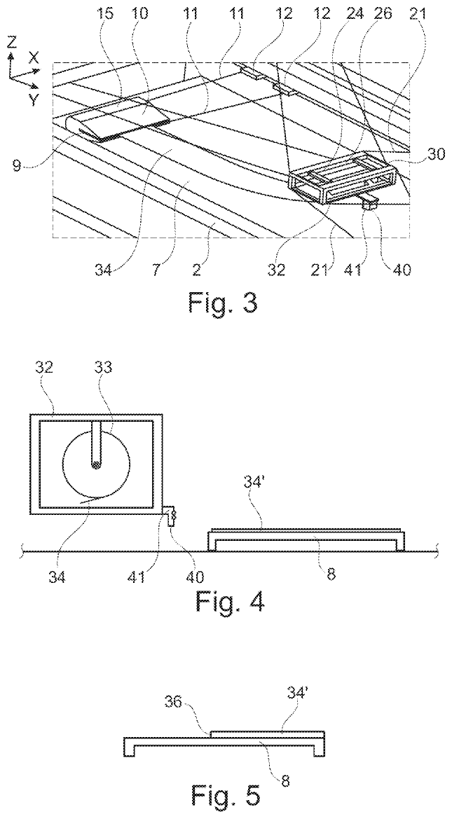

The draping line 7 is delimited laterally, parallel to a draping axis Y, by two lateral walls 13, extending on a portion of the height of the uprights 4 over the entire length of the line on both of its sides. On this draping line 7 there is positioned a system 15 for grasping the fabric, which can be seen better in FIG. 3, making it possible to retain the end of a strip of fabric, in this example forming a gripper 10. The gripper is supported by two cables 11, which themselves are connected to slides 12 which can slide in channels 14 formed in the lateral walls 13, and extending parallel to the draping axis Y. The cables 11 which support the gripper 10 are taut between the two lateral walls 13, and thus permit displacement of the gripper 10 along an axis X transverse to the draping axis Y, as well as the possibility of displacement along the axis Y by means of slides 12 which are mobile in the channels 14. The displacement along the transverse axis X is carried out for example by means of adjustment of the length of the cables 11 on both sides of the gripper 10, transversely to the gripper. Finally, by tightening or releasing the cables 11, the gripper 10 can be displaced in height along the vertical axis Z between a maximum height corresponding to the height of the channels 14, and a minimum height corresponding to the level of the depositing line 7. The gripper 10 itself comprises a jaw 9 which can occupy an open position and a closed position, the closed position making possible the gripping, as illustrated in FIG. 1, and thus the retention of an end of a strip or fold or band of fabric made of composite material to be deposited for the draping.

As a variant, the system 15 for grasping the fabric comprises a system for adhesion or laying of an adhesive in order to retain an end of the strip of fabric to be draped.

The installation 1 also comprises a parallel robot 20 with cables, comprising a plurality of cables 21, of which there are eight in this example, and a mobile platform 30. The cables 21 each extend between a point 22 of anchorage on the platform 30, and an anchorage 23 which is connected to the fixed structure 2. The platform 30 is thus connected by the cables 21 to the fixed structure 2.

It will be appreciated that, in a known manner, the cable-driven parallel robot 20 comprises a motor assembly in order to carry out the winding or unwinding of the cables 21, which motor assembly is not shown in the example illustrated for the sake of clarity of the drawing. The robot also comprises a control assembly, which makes it possible in particular to control the winding and unwinding of the cables 21 by means of the motor assembly, and thus the position and displacement of the platform 30.

Independently of the platform 30, this cable-driven parallel robot 20 can be as described in patent application EP 2 982 483, or different from this.

The presence in this example of eight cables 21 allows the robot to have six degrees of freedom, i.e. three degrees of freedom in translation along the axes X, Y and Z, and three degrees of freedom in rotation around these same axes.

According to other variants, not illustrated, the cable-driven parallel robot comprises only seven cables, or on the contrary comprises more than eight cables.

The platform 30 is configured to support at least one roll, in this case a single roll 33, of a fabric 34 which is made of composite material, preferably NCF, and to permit its unwinding in order to carry out draping of a preform, in particular a dry preform, by controlled displacement of the platform.

As shown in greater detail in FIGS. 2 and 3, the platform 30 comprises a frame 31, which is parallelepiped and hollow in this example, supporting the anchorages 22 and a support 32 for the roll 33. In this example, the support 32 for the roll(s) supports only a single roll 33, but a departure from the invention is not constituted if the support 32 supports a plurality of rolls 33, in particular two rolls 33.

In this example, the support 32 is fitted such as to be mobile in translation relative to the frame 31. In fact, the frame 31 comprises a securing system 24 comprising a mechanical system which permits guided displacement, consisting in this example of a slide 26 formed in a lower face of each of the upper cross-members 25 of the frame 31, extending parallel to the axis X. The slides 26 make it possible to receive tongues 35 of the support, of which there are two in this example, extending parallel to the draping axis Y. As can be seen in FIG. 1, the tongues 35 can slide transversely to the draping axis Y parallel to the transverse axis X, in the slides 26, in order to permit relative movement in translation of the support 32 in relation to the frame 31. Locking means can be provided in order to block the tongues 35 in the required position relative to the slides 26. The platform 30 can comprise an actuation system which permits displacement of the tongues 35 in the slides 26.

According to an embodiment not illustrated, the support 32 is fitted such as to be mobile in translation and in rotation, or in rotation alone, relative to the frame 31, the latter then comprising an alternative securing system. According to another embodiment not illustrated, the support 32 is fitted fixed relative to the frame 31. In this last case, the frame 31 of the platform 30 can itself form the support 32 for the roll(s).

The platform 30 comprises means 40 for perception of the relief and/or contrast of appearance, in this case formed by a laser profile meter 41, which makes it possible to measure in real time, during the draping, the length of the strip deposited by draping, and/or to situate precisely the edge of a strip or band already deposited by draping relative to a band being deposited. In this example, the platform 30 also comprises a system for correction of the position of the band, such as, according to the data received from the means 40 for perception, to correct the trajectory of the platform if applicable, by displacing the platform 30 according to its degrees of freedom, or by making the support 32 slide relative to the chassis 31 before draping, or in real-time during the draping.

In the example illustrated, the laser profile meter 41 forming the means 40 for perception is at the front, secured on a beam 5 of the platform 30, and extending downwards from the platform, on the side where the strip of fabric 34 exits.

According to another example illustrated in FIG. 4, the laser profile meter 41 is integral in displacement with the support 32 for the roll(s). It should be noted that, for the sake of clarity, this figure represents the support 32 only partially and highly schematically, and does not show the remainder of the robot.

The support 32 can also comprise a system 44 for guiding the fabric 34, for example comprising a slot 45 as shown in FIG. 2, permitting the passage of the fabric, and/or plates and/or rollers which permit the guiding of the fabric. It should be noted that this system 44 for guiding the fabric or a part of it, for example the slot 45, can constitute a fixed reference for the positioning of an edge of the fabric 34, for example, which is useful for example in order to control the positioning of the platform 30 and/or the support 32 for the roll.

The installation 1 makes it possible to carry out draping of preforms in an automated manner, in particular draping of dry large-sized preforms, for example in the fields of renewable energy, the motor vehicle industry or aeronautics, such as blades of wind turbines, motor vehicle floors, aeronautical wing panels, or the like. It should be noted that the draping of an elongate form, for example a blade of a wind turbine, can be carried out longitudinally or transversely relative to the elongate form to be draped. The installation and displacement of the robot are adapted according to the longitudinal or transverse direction of the draping.

In the example illustrated, the draping line 7 does not comprise any mold or form, but a flat surface which can be constituted by one or a plurality of depositing or draping tables 8, one of which is shown in the example illustrated in FIGS. 4 and 5. According to a variant, the draping line 7 can comprise a form which is not flat, for example curved, on which the draping is carried out.

The method for draping by means of the installation 1 can be carried out as follows.

By means of the assembly for control of the robot 20, the displacement of the mobile platform 30 is controlled by means of the cables 21, by acting on the length of the cables thanks to the motor assembly, and the roll 33 of fabric 34 made of composite material is unwound such as to provide the draping. The speed of displacement of the platform 30 along the draping axis Y is dependent on the speed of unwinding of the roll 33.

As far as the displacement of the platform 30 during the draping is concerned, the robot 20 is designed to ensure the linear displacement of the platform along the draping axis Y, at a constant altitude along the vertical axis Z, and at a speed which is correlated to the unwinding of the roll 33 of fabric 34. The displacement of the platform 30 along the axis X transverse to the draping axis Y can be designed to be a slight as possible. It should be noted that the displacements of the platform 30 associated with the depositing of the band of fabric 34 for the draping need not be limited only to the movements along the draping axis Y. In fact, all the movements on the plane (X, Y) can be carried out depending on the preform to be produced.

When the required length of fabric 34 has been unwound, it is possible to displace the platform 30 vertically, in particular downwards, whilst maintaining the fabric taut, and the fabric is cut, in particular by means of a cutting system. As a variant, the platform 30 is not displaced, in particular downwards, before the cutting is carried out.

Before unwinding the fabric 34 from the roll 33, it is possible to grip an end of the fabric by means of the gripper 10.

During the draping process, the laser profile meter 40 can situate the edge 36 of a strip or band 34′ already deposited by draping precisely relative to a band being deposited, as illustrated in FIGS. 4 and 5, thanks to the relief formed by this edge 36. The laser profile meter 41 is thus designed to detect a reference on the draping line 7 which can be the edge 36, or also an edge of the draping table 8, or another reference of the draping line 7. The system for correction of the position of the band of fabric then makes it possible, according to the information provided by the laser profile meter 40, to correct the trajectory of the platform 30 if applicable, by displacing it according to the degrees of freedom, or by displacing the support 32 relative to the frame 31, such as to deposit the band of fabric 34 so that its edge is contiguous with the edge 36. When the laser profile meter 41 is integral in displacement with the support 32 for the roll, the correction system makes it possible to adjust the position of the support 32 for the roll relative to the platform 30, in order if applicable to correct the position of the fabric to be unwound, before or during the draping.

The length of unwinding of the fabric can be monitored precisely by the system for control of the displacement of the platform, in association with the speed of unwinding of the fabric.

The invention is not limited to the example which has just been described.

In particular, the platform and the support can be configured to support simultaneously a plurality of rolls of fabric made of composite material.

Rolls of different widths can be supported in succession by the same roll support, within the limit of the dimensions of a drive roller. In this case, mobile elements can be provided, such as unnumbered flanges for retention of the roll, and lateral guides for the fabric, in particular the slot 45.

Since the cable-driven parallel robot does not permit the rotation of the platform by 180°, the installation can comprise a symmetrical platform positioned back to back with the platform 30, which makes it possible to carry out draping in an outward direction with the platform 30, and in a return direction with the symmetrical platform, in order to increase the pace of depositing or draping of two different materials or fabrics, with one type of material or fabric outwards and a different type of material of fabric on the return.

The means for perception of a relief and/or a contrast of appearance can be constituted by one or a plurality of thermal cameras. In this case, the heating of an edge of a band of fabric, or another spatial reference, makes it possible to detect the relief/contrast by means of the thermal camera(s).

1: A device comprising:
a mobile platform which is designed to equip a cable-driven parallel robot, wherein
the platform is configured to
support at least one roll of a fabric made of composite material, and
permit the unwinding of said at least one roll, in order to carry out draping of a dry preform, by controlled displacement of the platform above a draping line.

2: The device as claimed in claim 1, comprising a support for the at least one roll.

3: The device as claimed in the claim 2, wherein the support is connected to the platform by a securing system, the latter being configured to permit controlled displacement in translation and/or in rotation of the support relative to the remainder of the platform.

4: The device as claimed in claim 3, wherein the securing system includes a mechanical system which permits guided displacement, selected in the group including a slide, a rail, a roller, a sliding shaft, and any combination thereof.

5: The device as claimed in claim 1, further comprising means for rotation of the roll.

6: The device as claimed in claim 1, further comprising a system for cutting the fabric.

7: The device as claimed in claim 1, further comprising a system for guiding the fabric.

8: The device as claimed in claim 1, further comprising means for perception of the relief and/or of a contrast of appearance chosen from a group consisting of at least one laser profile meter and at least one thermal camera.

9: The device as claimed in claim 8, wherein the means for perception are integral in displacement with the support for the at least one roll.

10: The platform as claimed in claim 8, wherein the means for perception are configured to detect a reference on the draping line.

11: The platform as claimed in claim 8, further comprising a system for correction of the position of the fabric before draping, configured to take into consideration the data received by the means for perception and to command according to the data a displacement of the support for the at least one relative to the platform.

12: A cable-driven parallel robot, comprising:
the platform as claimed in claim 1;
a plurality of cables extending between a point of anchorage on the platform and an anchorage connected to a structure which is fixed in space;
a motor assembly in order to carry out the winding or unwinding of the cables; and
a control assembly in order to control the displacement of the platform and/or the displacement of the support for the roll(s) relative to the platform and/or the unwinding of the fabric from the roll.

13: The cable-driven parallel robot as claimed in claim 12, wherein the number of cables supporting the platform is equal to eight.

14: An installation for draping of preforms comprising:
a robot as claimed in claim 12 and a fixed structure.

15: The installation as claimed in claim 14, further comprising a draping line and a system for grasping fabric, which is designed to retain an end of the fabric of the roll during the draping.

16: A method for draping by an installation as claimed in claim 14, comprising
displacing the platform and unwinding the roll, in order to carry out the draping, the speed of unwinding of the roll being dependent on the speed of advance along the draping axis of the platform.

17: The method as claimed in claim 16, further comprising cutting the fabric whilst maintaining the fabric taut, to the required length of fabric unwound.

18: The method as claimed in the claim 17, further comprising retaining an end of the fabric of the roll before unwinding the fabric.

19: The method as claimed in claim 16, further comprising detecting, by the means for perception of the relief and/or a contrast of appearance, chosen from a group consisting of a laser profile meter and a thermal camera, a reference on the draping line chosen from a group consisting of an edge of a band of fabric already deposited, an edge of a draping table, and a reference on the draping line.

20: The method as claimed in claim 16, further comprising displacing the support for the at least one roll relative to the platform, in order to correct a position of the platform.
